(19) United States
(12) Patent Application Publication
(10) Pub. No.: US 2025/0264734 A1
(43) Pub. Date: Aug. 21, 2025

(54) GLASSES HAVING COUPLING BRIDGE

(71) Applicant: Coptiq Co, Ltd., Seoul (KR)

(72) Inventors: Woo Seok SUNG, Seoul (KR); Myung Gwon CHO, Seoul (KR)

(73) Assignee: Coptiq Co, Ltd., Seoul (KR)

(21) Appl. No.: 19/058,201

(22) Filed: Feb. 20, 2025

(30) Foreign Application Priority Data
Feb. 21, 2024 (KR) 10-2024-0024790

(51) Int. Cl. G02C 5/12; G02C 5/02

(52) U.S. Cl. CPC G02C 5/126; G02C 5/02

(57) ABSTRACT

Disclosed is a glasses having a coupling bridge, the glasses including glasses frames provided with a one-side glasses frame and the other-side glasses frame; a glasses frame bridge connecting the one-side glasses frame and the other-side glasses frame; and a coupling bridge that is coupled to the lower part of the glasses frame bridge and is coupled to the side surfaces of the one-side glasses frame and the other-side glasses frame, wherein, in the coupling bridge, a coupling portion is formed in a horizontal direction to be coupled to the glasses frame bridge, support portions are formed to extend downward from both ends of the coupling portion and to adhere closely to the glasses frames, and the coupling bridge is detachably coupled to the glasses frame bridge. According to the present disclosure, the rigidity of the glasses frame bridge may be improved, and the focal length between a user and glasses lenses may be maintained constant.

### CROSS-REFERENCE TO RELATED APPLICATION

This application claims priority to Korean Patent Application No. 10-2024-0024790, filed on Feb. 21, 2024, in the Korean Intellectual Property Office, the disclosure of which is incorporated herein by reference.

### BACKGROUND OF THE DISCLOSURE

### Field of the Disclosure

The present disclosure relates to a glasses having a coupling bridge, the glasses including a glasses frame bridge connecting glasses frames and the coupling bridge coupled to the lower part of the glasses frame bridge. According to the present disclosure, this configuration may improve the rigidity of the glasses frame bridge and prevent bending and twisting of the glasses frames, thereby maintaining a constant focal length of glasses lenses in a user.

### Description of the Related Art

In general, glasses are used to correct the user's vision, protect the eyes, or for fashion purposes. Glasses consist of a pair of glasses frames, a bridge that connects the glasses frames, glasses lenses that fit into the glasses frames, and temples that allow the glasses to hang on the user's ears.

When a user wipes glasses having such a structure or when the glasses collide with another person or object, tensile force, lateral pressure, or external force causing bending and twisting may be applied to the glasses. In such cases, the glasses may be broken. In particular, the bridge portion of the glasses is generally designed to be thin. Accordingly, there is a problem that the bridge portion is very vulnerable to tensile force, lateral pressure, or external force causing bending or twisting.

In addition, the nose pad of the glasses is a component that is configured to rest on the user's nose, allowing the user to wear the glasses stably. As a user repeatedly wears glasses, the nose pad easily becomes dirty due to foreign substances and oils from the skin around the nose. However, since the nose pad is usually assembled as an integral part of the glasses frame, it is difficult to replace just the nose pad.

### SUMMARY OF THE DISCLOSURE

Therefore, the present disclosure has been made in view of the above problems, and it is an object of the present disclosure to provide a glasses including a coupling bridge coupled to the lower part of a glasses frame bridge to improve the rigidity of the glasses frame bridge.

It is another object of the present disclosure to provide a glasses including a coupling bridge located between the lower part of a glasses frame bridge and the inner side of a glasses frame to maintain a constant focal length between a user and glasses lenses by preventing deformation of the glasses due to external force.

It is yet another object of the present disclosure to provide a glasses having a coupling bridge, wherein, to ensure that a glasses frame bridge and the coupling bridge are stably combined, a glasses frame is provided with a plurality of protrusions and the glasses frame bridge is provided with coupling tips, and the glasses frame bridge is inserted into a plurality of grooves formed in the coupling bridge.

The purposes of the embodiments of the present disclosure are not limited to the purposes mentioned above, and other purposes not mentioned will be clearly understood by a person skilled in the art to which the present disclosure belongs from the description below.

In accordance with one aspect of the present disclosure, provided is a glasses having a coupling bridge, the glasses including glasses frames provided with a one-side glasses frame and the other-side glasses frame; a glasses frame bridge connecting the one-side glasses frame and the other-side glasses frame; and a coupling bridge that is coupled to a lower part of the glasses frame bridge and is coupled to side surfaces of the one-side glasses frame and the other-side glasses frame, wherein, in the coupling bridge, a coupling portion is formed in a horizontal direction to be coupled to the glasses frame bridge, support portions are formed to extend downward from both ends of the coupling portion and to adhere closely to the glasses frames, and the coupling bridge is detachably coupled to the glasses frame bridge.

In addition, according to one embodiment of the present disclosure, the coupling bridge may include a guide portion in which a groove of a predetermined depth is formed along an outer circumferential surface of an edge portion of the coupling portion and the support portions.

In addition, according to one embodiment of the present disclosure, the glasses frame bridge may include coupling tips provided to enable the coupling bridge to be coupled to a lower part of the coupling portion.

In addition, according to one embodiment of the present disclosure, the one-side glasses frame and the other-side glasses frame may include a plurality of guide protrusions provided on an inner edge thereof; and a plurality of support protrusions provided on a lower part of the guide protrusions.

In addition, according to one embodiment of the present disclosure, the coupling bridge may include a coupling groove formed in the coupling portion and provided so that the coupling tips are inserted in a fitting manner; guide grooves formed on a side surface of the support portions and provided so that the guide protrusions are inserted; and support grooves formed on a side surface of the support portions and provided so that the support protrusions are inserted.

In addition, according to one embodiment of the present disclosure, the coupling bridge may include a nose support provided in the support portions to support a nose of a user.

In addition, according to one embodiment of the present disclosure, the support portions may be formed to curve downward and outward so as to correspond to a shape of an inner side of the glasses frame.

In addition, according to one embodiment of the present disclosure, the coupling bridge may be formed of an elastic material to resist lateral pressure from the glasses frame.

In addition, according to one embodiment of the present disclosure, the support protrusions may be provided in a wedge shape protruding upward.

In addition, according to one embodiment of the present disclosure, the nose support may be formed by digital modeling and 3D printing of a nose shape of a user.

In addition, according to one embodiment of the present disclosure, the coupling bridge may be formed in a color different from that of the glasses frames or the glasses frame bridge.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a drawing illustrating a glasses having a coupling bridge according to one embodiment of the present disclosure;

FIG. 2 is a drawing illustrating the coupling of a coupling bridge in a glasses having a coupling bridge according to one embodiment of the present disclosure;

FIG. 3 is a drawing illustrating a coupling bridge of a glasses having a coupling bridge according to one embodiment of the present disclosure;

FIG. 4 is a drawing illustrating the interior of a coupling bridge of a glasses having a coupling bridge according to one embodiment of the present disclosure;

FIG. 5 is a drawing illustrating the coupling of a coupling bridge and a glasses frame bridge in a glasses having a coupling bridge according to one embodiment of the present disclosure; and

FIG. 6 is a drawing illustrating a cross-section of a guide portion of a glasses having a coupling bridge according to one embodiment of the present disclosure.

### DETAILED DESCRIPTION OF THE DISCLOSURE

The present disclosure will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. The present disclosure is defined only by the categories of the claims. Throughout the specification, identical reference numerals refer to identical components.

In addition, in the following description of the present disclosure, a detailed description of known functions and configurations incorporated herein will be omitted when it may make the subject matter of the present disclosure unclear. The terms used in the specification are defined in consideration of functions used in the present disclosure, and can be changed according to the intent or conventionally used methods of clients, operators, and users. Accordingly, definitions of the terms should be understood on the basis of the entire description of the present specification. Hereinafter, embodiments of the present disclosure will be described in detail with reference to the attached drawings.

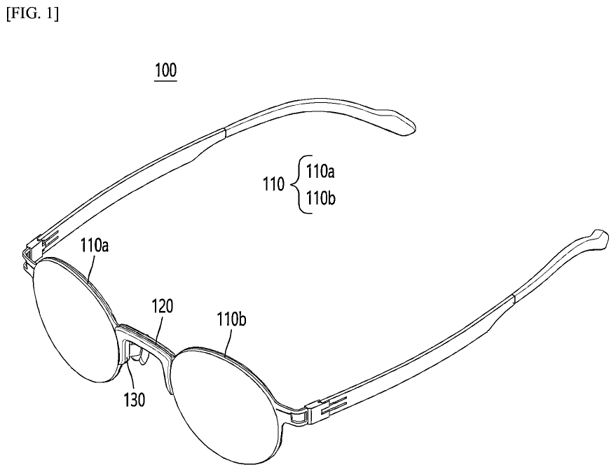

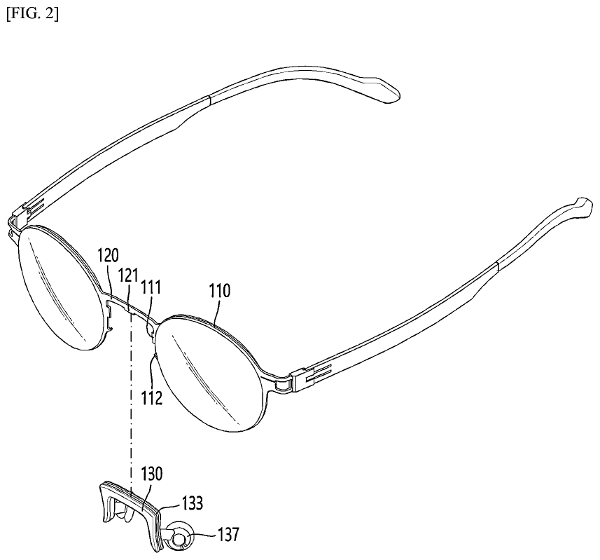

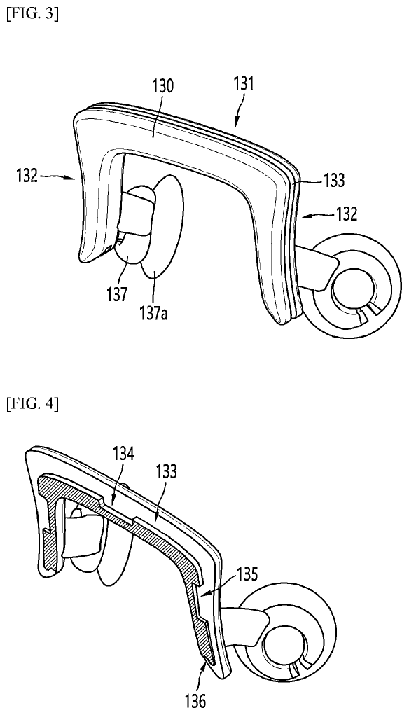

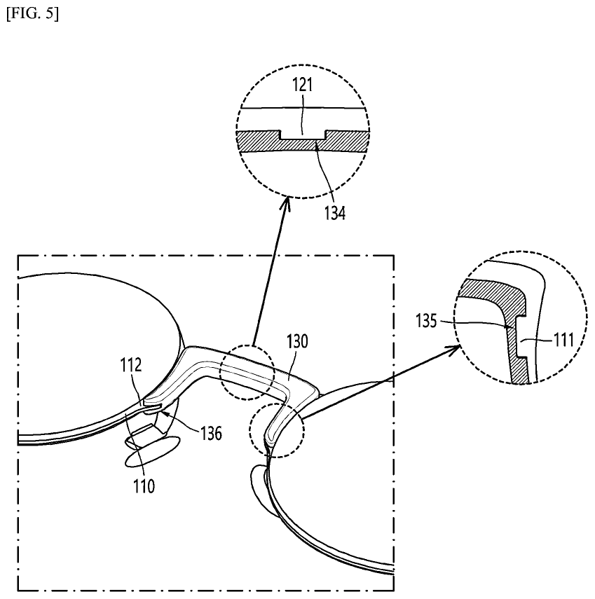

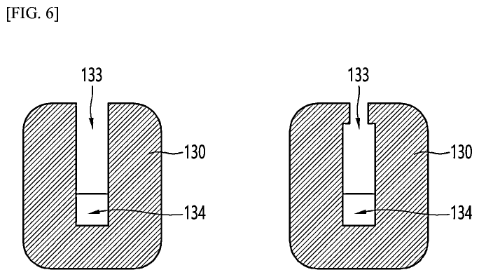

FIG. 1 is a drawing illustrating a glasses having a coupling bridge according to one embodiment of the present disclosure, FIG. 2 is a drawing illustrating the coupling of a coupling bridge in a glasses having the coupling bridge according to one embodiment of the present disclosure, FIG. 3 is a drawing illustrating a coupling bridge of a glasses having a coupling bridge according to one embodiment of the present disclosure, FIG. 4 is a drawing illustrating the interior of a coupling bridge of a glasses having a coupling bridge according to one embodiment of the present disclosure, FIG. 5 is a drawing illustrating the coupling of a coupling bridge and a glasses frame bridge in a glasses having a coupling bridge according to one embodiment of the present disclosure, and FIG. 6 is a drawing illustrating a cross-section of a guide portion of a glasses having a coupling bridge according to one embodiment of the present disclosure.

Referring to FIGS. 1 to 6, the glasses 100 having a coupling bridge according to one embodiment of the present disclosure may include glasses frames 110, a glasses frame bridge 120, a coupling bridge 130, and the like.

The glasses frames 110 may consist of a one-side glasses frame 110a and the other-side glasses frame 110b, and glasses lenses may be combined with the one-side glasses frame 110a and the other-side glasses frame 110b to support the glasses lenses. In addition, the one-side glasses frame 110a and the other-side glasses frame 110b may be connected to each other by being joined to both ends of the glasses frame bridge 120.

Guide protrusions 111, support protrusions 112, and the like may be provided along the outer edges of the glasses frames 110. The guide protrusions 111 and the support protrusions 112 may be provided in multiples. When the coupling bridge 130 is combined with the glasses frame bridge 120, by inserting the guide protrusions 111 and the support protrusions 112 into the guide grooves 135 and the support grooves 136 of the coupling bridge 130, the coupling bridge 130 may be stably connected to the glasses frame bridge 120.

The guide protrusions 111 may be formed on the inner sides of the one-side glasses frame 110a and the other-side glasses frame 110b, and may be formed at corresponding positions in the one-side glasses frame 110a and the other-side glasses frame 110b. In addition, the guide protrusions 111 are inserted into the guide grooves 135, and the guide protrusions 111 may be formed in a shape corresponding to the shape of the guide grooves 135.

The support protrusions 112 may be formed on the inner sides of the one-side glasses frame 110a and the other-side glasses frame 110b, and may be formed at corresponding positions in the one-side glasses frame 110a and the other-side glasses frame 110b. In addition, the support protrusions 112 may be formed below the guide protrusions 111, and the support protrusions 112 may be inserted into the support grooves 136 formed in the coupling bridge 130.

In particular, the support protrusions 112 according to one embodiment of the present disclosure may be formed in a wedge shape protruding upward. When the coupling bridge 130 is coupled to the glasses frame bridge 120, the side surfaces of the coupling bridge 130, i.e., support portions 132, may move upward while coming into contact with the side surfaces of the one-side glasses frame 110a and the other-side glasses frame 110b. When the support protrusions 112 are formed to protrude downward or forward, the coupling bridge 130 may be caught by the support protrusions 112 or may be combined while receiving resistance, making it difficult to combine the coupling bridge 130 with the glasses frame bridge 120.

However, when the support protrusions 112 are formed as a wedge shape protruding upward, the coupling bridge 130 is easily combined with the glasses frame bridge 120. In addition, the coupling bridge 130 may be prevented from being separated from the glasses frame bridge 120 by the support protrusions 112, so that the coupling bridge 130 may be stably connected to the glasses frame bridge 120.

In addition, the support protrusions 112 may be inserted into the support grooves 136 formed in the lower part of the coupling bridge 130. In particular, since the support grooves 136 are formed across the lower surface and the lower edge of the coupling bridge 130, when the support protrusions 112 are inserted into the support grooves 136, the support protrusions 112 may support the coupling bridge 130 from the lower side of the coupling bridge 130.

The glasses frame bridge 120 is a member that connects the one-side glasses frame 110a and the other-side glasses frame 110b, and the one-side glasses frame 110a and the other-side glasses frame 110b may be respectively connected to both ends of the glasses frame bridge 120. The glasses frame bridge 120 may support the one-side glasses frame 110a and the other-side glasses frame 110b so that the one-side glasses frame 110a and the other-side glasses frame 110b are not deformed and are be positioned in the original positions thereof against various forces such as compression force, tensile force, and bending force applied to the one-side glasses frame 110a and the other-side glasses frame 110b.

In addition, according to one embodiment of the present disclosure, the glasses frame bridge 120 has one or more coupling tips 121 formed on a lower surface thereof, and the coupling bridge 130 may be coupled to the glasses frame bridge 120 by inserting the coupling tips 121 into a coupling groove 134 of the coupling bridge 130.

The coupling tips 121 may be formed to correspond to the shape of the coupling groove 134, and the coupling tips 121 may be formed at a position corresponding to the position where the coupling groove 134 is formed. Accordingly, the coupling bridge 130 may be combined with the glasses frame bridge 120 by inserting the coupling tips 121 into the coupling groove 134 in a fitting manner.

In addition, according to one embodiment of the present disclosure, the entrance portion of a guide portion 133 may have a protruding portion formed therein. Here, the terminal portion of the coupling tips 121 may be formed into a convex elliptical spherical shape or a convex polyhedral shape, and the thickness of the terminal portion of the coupling tips 121 may be formed to be larger than the width of the guide portion 133. Accordingly, the coupling tips 121 may be easily inserted into the guide portion 133 in a fitting manner, and even when an external force is applied, the coupling tips 121 may be prevented from being separated from the guide portion 133 by the convex portion of the coupling tips 121. In this way, the coupling tips 121 are fitted into the inner side of the guide portion 133 in a force-fitting manner, so that the coupling bridge 130 may be stably coupled to the glasses frame bridge 120.

The coupling bridge 130 may be coupled to the lower part of the glasses frame bridge 120 and to the side surfaces of the one-side glasses frame 110a and the other-side glasses frame 110b.

The coupling bridge 130 may be provided with a coupling portion 131 formed in a horizontal direction to be combined with the glasses frame bridge 120. In addition, the coupling bridge 130 may be provided with the support portions 132 extending downward from both ends of the coupling portion 131 and coupled with the glasses frames 110. Here, the support portions 132 are not formed independently from the coupling portion 131, but rather are formed by both ends of the coupling portion 131 extending downward.

The coupling bridge 130 according to one embodiment of the present disclosure may be formed in a different color from the colors of the glasses frames 110, the glasses frame bridge 120, etc. Accordingly, the coupling bridge 130 may be distinguished from other components of the glasses 100 (e.g., the glasses frames 110, the glasses frame bridge 120, etc.), thereby providing a visual aesthetic to a user in terms of design and creating differentiation from existing glasses.

The coupling portion 131 may be combined with the glasses frame bridge 120 by the coupling of the coupling tips 121 and the coupling groove 134, and the coupling portion 131 may be formed to have a length corresponding to the length of the glasses frame bridge 120.

In addition, the support portions 132 may be formed to extend downward from both ends of the coupling portion 131, and may be formed to correspond to the shapes of the inner surfaces of the one-side glasses frame 110a and the other-side glasses frame 110b so as to be combined with the glasses frames 110. That is, the support portions 132 may be formed in a shape that is curved outwardly according to the shape of the glasses frames 110 while extending downward from both ends of the coupling portion 131. Accordingly, when the coupling bridge 130 is coupled to the glasses frame bridge 120, the support portions 132 of the coupling bridge 130 may be in close contact with the one-side glasses frame 110a and the other-side glasses frame 110b.

In general, glasses, especially the bridge part of glasses, can be subject to external forces such as lateral pressure, tensile force, and forces due to bending and twisting. In addition, the bridge part may be formed of a thin and light material (e.g., titanium material) so that a large load is not applied to the user's nose. Accordingly, the bridge part is the part of the glasses that is most easily damaged.

The coupling bridge 130 according to one embodiment of the present disclosure may be tightly coupled to the glasses frame bridge 120 so as to support the bridge part, that is, the glasses frame bridge 120, and may be formed of a polymer material capable of elastic deformation. Accordingly, when an external force is applied to the glasses frames 110 or the glasses frame bridge 120, the coupling bridge 130 may absorb the external force by elastically deforming, and prevent the glasses frames 110 or the glasses frame bridge 120 from being damaged or deformed. In particular, when the coupling bridge 130 is combined with the glasses frame bridge 120, the rigidity of the glasses frame bridge 120 may be improved. That is, by improving the rigidity of the glasses frame bridge 120, the shape of the glasses may be maintained, thereby preventing the glasses frames 110 from being deformed by external force or the glasses from being frequently detached from a user. In particular, when the glasses frames 110 are deformed, the focus of the lenses of the glasses may be incorrect, but as the rigidity of the glasses frame bridge 120 is improved, the focal length and angle of the lenses may be maintained.

The coupling bridge 130 according to one embodiment of the present disclosure is tightly coupled to the glasses frame bridge 120 and the glasses frames 110, thereby preventing the glasses frame bridge 120 and the glasses frames 110 from being deformed. In addition, since the coupling bridge 130 may be used as a replaceable type, when the elasticity of the coupling bridge 130 decreases, the glasses frames 110 and the glasses frame bridge 120 may be continuously supported by replacing the coupling bridge 130.

The guide portion 133 may be formed along the outer edge of the coupling portion 131 and the support portions 132. That is, the guide portion 133 may be formed continuously along the outer edge of the coupling bridge 130 in the form of a groove.

When the coupling bridge 130 is coupled to the glasses frame bridge 120, the coupling bridge 130 may be moved toward the glasses frame bridge 120 as the support protrusions 112 and the guide protrusions 111 are sequentially received on the inner side of the side surface of the guide portion 133. Thereafter, as the glasses frame bridge 120 is received into the inner side of the upper surface of the guide portion 133, the coupling tips 121 are inserted into the coupling groove 134, the guide protrusions are inserted into the guide grooves 135, and the support protrusions 112 are inserted into the support grooves 136, respectively, so that the coupling bridge 130 may be combined with the glasses frame bridge 120.

In addition, referring to FIG. 6, according to one embodiment of the present disclosure, the guide portion 133 may form a protruding portion having a step in the entrance portion. That is, when the terminal portion of the coupling tips 121 is formed as a convex sphere or a convex polyhedron, the coupling tips 121 may be fitted into the protruding portion (drawing number omitted) of the guide portion 133 in a force-fitting manner. In addition, after the coupling tips 121 are fitted, the protruding portion (drawing number omitted) may prevent the coupling tips 121 from coming off from the guide portion 133.

The coupling groove 134 may be formed in a groove shape in the coupling portion 131 of the coupling bridge 130, and the coupling groove 134 may be provided to correspond to the position where the coupling tips 121 are formed and the size of the coupling tips 121 so that the coupling tips 121 may be inserted into the coupling groove 134.

The guide grooves 135 may be formed in a groove shape in the support portions 132 of the coupling bridge 130, and the guide grooves 135 may be provided to correspond to the positions at which the guide protrusions 111 are formed and the sizes of the guide protrusions 111 so that the guide protrusions 111 may be inserted into the guide grooves 135.

The support grooves 136 may be formed in a groove shape in the support portions 132 of the coupling bridge 130, and the support grooves 136 may be provided to correspond to the positions where the support protrusions 112 are formed and the sizes of the guide protrusions 111 so that the support protrusions 112 may be inserted into the support grooves 136. In particular, the support grooves 136 may be formed across the lower surface of the support portions 132 and the inner side edge of the lower part. Accordingly, when the support protrusions 112 are inserted into the support grooves 136, the support protrusions 112 may support the lower part of the support portions 132 by being inserted into the lower surface of the support portions 132 and the inner side edge of the lower part.

A nose support 137 may be formed to protrude from the support portions 132 of the coupling bridge 130 to the inner side, that is, toward a user, so as to be placed on the user's nose. In addition, a nose support pad 137a made of silicone may be coupled to the terminal portion of the nose support 137. The terminal portion of the nose support 137 may be formed in a circular ring shape with a gap formed in one portion. In addition, a convex portion protruding in a spherical shape may be formed at the center of the inner side of the nose support pad 137a. The diameter of the convex portion may be formed to correspond to the inner diameter of the circular ring of the terminal portion of the nose support 137. Accordingly, the nose support pad 137a may be coupled to the terminal portion of the nose support 137 in a fitting manner.

In general, the nose support pad 137a is the part that comes into direct contact with the user's nose and may easily become dirty. Since the nose support 137 according to one embodiment of the present disclosure is provided on the coupling bridge 130, when the coupling bridge 130 is replaced, the nose support 137 may also be replaced. In addition, the nose support pad 137a is connected to the nose support 137 in a fitting manner, making it easy to replace only the nose support pad 137a.

In addition, the coupling bridge 130, the nose support 137, or the nose support pad 137a may be designed to fit the shape of the user's nose and formed by 3D printing. Typically, the nose support 137 or the nose support pad 137a of the glasses is provided in a standardized state and is manually fitted to the user by a person's hand. In this way, since the shape of the nose is different for each user, the accuracy of the glasses fitting may be determined by the skill of the person doing the fitting.

However, the coupling bridge 130, the nose support 137, or the nose support pad 137a according to one embodiment of the present disclosure may be custom-designed by modeling the shape of the user's nose as digital data and formed using 3D printing. For example, the coupling bridge 130, the nose support 137, or the nose support pad 137a may be formed by accurately modeling the protrusion length and protrusion angle of the nose support 137 in the coupling bridge 130 and the angles at which the nose support pad 137a contacts the left and right sides of the user's nose.

According to the present disclosure, by including a coupling bridge coupled to the lower part of a glasses frame bridge in a glasses, the rigidity of the glasses frame bridge can be improved.

In addition, according to the present disclosure, by placing a coupling bridge between the lower part of a glasses frame bridge and the inner side of a glasses frame, deformation of a glasses due to external force can be prevented, and the focal length between a user and glasses lenses can be maintained constant.

In addition, according to the present disclosure, by providing a plurality of protrusions on a glasses frame and coupling tips on a glasses frame bridge, the glasses frame bridge can be inserted into a plurality of grooves formed on a coupling bridge to stably combine the glasses frame bridge and the coupling bridge.

In addition, according to the present disclosure, by custom-designing a coupling bridge, a nose support, or a nose support pad using 3D printing, a glasses optimized for the shape of the user's face can be provided.

Although the above description has presented and described various embodiments of the present disclosure, the present disclosure is not necessarily limited thereto, and a person with ordinary skill in the technical field to which the present disclosure belongs will easily understand that various substitutions, modifications, and changes are possible within a scope that does not depart from the technical idea of the present disclosure.

[Description of Symbols]

100: GLASSES HAVING COUPLING BRIDGE
110: GLASSES FRAME
111: GUIDE PROTRUSIONS
112: SUPPORT PROTRUSIONS
120: GLASSES FRAME BRIDGE
121: COUPLING TIPS
130: COUPLING BRIDGE
131: COUPLING PORTION
132: SUPPORT PORTIONS
133: GUIDE PORTION
134: COUPLING GROOVE
135: GUIDE GROOVES
136: SUPPORT GROOVES
137: NOSE SUPPORT

What is claimed is:

1. A glasses having a coupling bridge, comprising:
glasses frames provided with a one-side glasses frame and the other-side glasses frame;
a glasses frame bridge connecting the one-side glasses frame and the other-side glasses frame; and
a coupling bridge that is coupled to a lower part of the glasses frame bridge and is coupled to side surfaces of the one-side glasses frame and the other-side glasses frame,
wherein, in the coupling bridge, a coupling portion is formed in a horizontal direction to be coupled to the glasses frame bridge, support portions are formed to extend downward from both ends of the coupling portion and to adhere closely to the glasses frames, and the coupling bridge is detachably coupled to the glasses frame bridge.

2. The glasses according to claim 1, wherein the coupling bridge comprises a guide portion in which a groove of a predetermined depth is formed along an outer circumferential surface of an edge portion of the coupling portion and the support portions.

3. The glasses according to claim 2, wherein the glasses frame bridge comprises coupling tips provided to enable the coupling bridge to be coupled to a lower part of the coupling portion.

4. The glasses according to claim 3, wherein the one-side glasses frame and the other-side glasses frame comprise a plurality of guide protrusions provided on an inner edge thereof; and a plurality of support protrusions provided on a lower part of the guide protrusions.

5. The glasses according to claim 4, wherein the coupling bridge comprises a coupling groove formed in the coupling portion and provided so that the coupling tips are inserted in a fitting manner;
guide grooves formed on a side surface of the support portions and provided so that the guide protrusions are inserted; and
support grooves formed on a side surface of the support portions and provided so that the support protrusions are inserted.

6. The glasses according to claim 5, wherein the coupling bridge comprises a nose support provided in the support portions to support a nose of a user.

7. The glasses according to claim 1, wherein the support portions are formed to curve downward and outward so as to correspond to a shape of an inner side of the glasses frame.

8. The glasses according to claim 1, wherein the coupling bridge is formed of an elastic material to resist lateral pressure from the glasses frame.

9. The glasses according to claim 4, wherein the support protrusions are provided in a wedge shape protruding upward.

10. The glasses according to claim 6, wherein the nose support is formed by digital modeling and 3D printing of a nose shape of a user.

11. The glasses according to claim 1, wherein the coupling bridge is formed in a color different from that of the glasses frames or the glasses frame bridge.
